(19) United States
(12) Patent Application Publication
(10) Pub. No.: US 2006/0213485 A1
(43) Pub. Date: Sep. 28, 2006

(54) Vacuum flushing of an injector for internal combustion engines

(76) Inventor: Klaus Balling, POSTFACH 3002 20, 70442 sUTUTTGART (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/551,116

(22) PCT Filed: Sep. 29, 2003
(86) PCT No.: PCT/DE03/03236

§ 371 Date: Sep. 28, 2005

(30) Foreign Application Priority Data
Mar. 30, 2003 (DE) 103-14-454.4

(51) Int. Cl. F02M 69/46; F02M 37/20

(52) U.S. Cl. 123/461; 123/456

(57) ABSTRACT

A method for flashing air from an injection valve such as a common rail injector for an internal combustion engine which injection valve on being put into operation is initially at least partly filled with air and to which a liquid medium is supplied via a typical connection for supplying fuel, including pressurizing an inner chamber of the injection valve to a pressure that is reduced compared to normal operation, whereby existing air bubbles increase in volume compared to the volume in normal operation, and flushing the medium contained in the aforementioned inner chamber at a reduced pressure that remains at least approximately constant, and selectively repeating these steps multiple times. The operational readiness of the injector, despite air in the gas phase that is initially contained inside it in the liquid medium, can be brought about rapidly as a result. An apparatus for performing the method is also disclosed.

The invention relates to a method as defined by the preamble to claim 1. The invention is particularly important in common rail injectors. An injector of this kind, which does not itself cause any pressure increase but instead is supplied directly with the fuel under pressure for injection into the engine, in particular a diesel engine, reacts sensitively to air components in the medium processed by the injector. This medium in the case of an operationally ready diesel engine is diesel fuel, but in the testing field, the testing medium in measurement and testing of the injector is typically not diesel fuel but rather a hydraulically similar material that is preferably noncombustible. Air inclusions in the injector, which are present when the injector is filled with the medium before it is put into operation, must be flushed out to a low-pressure connection (leakage connection) of the injector via the volumetric flow of the return quantity of the medium that results during normal operation, for instance from leak fuel quantities and/or from the actuation of a control valve.

The air, present in the gas phase, has much greater compressibility than the liquid medium, and as a result the dynamic damping behavior in the injector, in particular in a magnet valve, is influenced in a nonreplicable way and has a direct effect on the injection quantity. This makes measurements more difficult in the testing field. In the case of a vehicle that has a diesel engine and is ready for operation and in which an injector has for instance just been replaced in the repair facility and is filled for the first time with diesel fuel, the existing gaseous air once again causes nonreplicable injection events, which for a brief time can make driving feel uncomfortable and make it impossible to meet the required values for exhaust gas. Dissolved air contained in the medium is not considered problematic in this particular application, as long as the air remains dissolved during the entire operating state of the injector and does not become gaseous.

The magnet valve mentioned may in particular be a control valve, which via an outflow throttle enables the outflow of medium from a control chamber of a stroke-controlled injector in order to bring about an injection event, and which blocks to end the injection event. Various moving and nonmoving parts of the magnet valve (for instance, see FIG. 2: armature, at least one spring, closure element to be actuated for enabling the outflow; nonmoving guide of the armature) are disposed in a function chamber. This function chamber and the parts of the control valve that are contained in it have numerous edges and protrusions, which have a tendency to trap air bubbles, if the air bubbles do not exceed a certain size, so that in normal operation it can take considerable time (from many seconds to approximately 1 minute) until this function chamber contains only so little air in the gaseous state that practically no disruption of the function of the internal combustion engine, for instance in measurement, occurs.

The function chamber generally communicates directly with a low-pressure connection, that is, without the interposition of special blocking devices. In operation of the injector at ambient pressure, which for the sake of simplicity is considered to be 1 bar (absolute) or 0 bar (relative), in internal combustion engines at least a slight overpressure (such as 0.5 bar) relative to the ambient pressure is often maintained at the low-pressure connection, to prevent leak fuel lines from running empty. Combustion power plants exist in which a considerably greater pressure prevails in operation at the low-pressure connection of the injector (for instance, 10 bar), such as in injectors whose control valve is actuated by a piezoelectric actuator, preferably via a hydraulic coupler. Even in this kind of injector, it may be advantageous to make it air-free with the invention.

The object of the invention is to bring about the operational readiness of the injector rapidly, despite gaseous air contained inside it in the liquid medium, or in other words in the case of a pneumatic/hydraulic filling of the injector.

### ADVANTAGES OF THE INVENTION

The characteristics of the method of the invention as described in claim 1 have the effect that the gaseous air, because of the pressure drop, forms such large air bubbles that they cannot stay caught on protrusions of any kind in the injector. As a result, the air is maximally removed, and an unambiguously replicable fill state of the injector in testing in the testing field or in operation in a motor vehicle is quickly reached.

The pressure drop should not be so great that the vapor pressure of the liquid medium, or of parts of it, is reached or undershot. The rapid elimination of the return quantity enriched with gas bubbles can be speeded up by flushing them away with an air-free medium, at a considerably lower pressure than the common rail pressure. In the case of the motor vehicle, this medium may be fuel originating directly from the fuel tank.

The apparatus of the invention as defined by claim 4 has devices for connecting an injector to a source of high pressure of the medium and to a underpressure connection. A control device with control terminals of switching valves is advantageous and is also advantageously coupled to a trigger circuit for opening and closing the injection openings of the injector.

### DRAWING

A preferred embodiment of an arrangement with which one type of embodiment of a method of the invention can be realized is shown schematically in the drawing and will be described in further detail in the ensuing description. Shown are:

FIG. 1, a hydraulic basic circuit diagram of the arrangement for eliminating air inclusions from a common rail injector, an arrangement that is used both in the testing field, the first time the injection system is put into operation at the automobile manufacturer, or may also be present in a well-equipped automotive repair facility,

FIG. 2, a longitudinal section through a known stroke-controlled injector for diesel fuel, having a magnet valve, which via an outflow throttle controls the pressure in a control chamber for the sake of actuating a valve piston for opening and closing injection openings; and

FIG. 3, a timing diagram of the triggering of the valves V1 through V4.

### DESCRIPTION OF THE EXEMPLARY EMBODIMENT

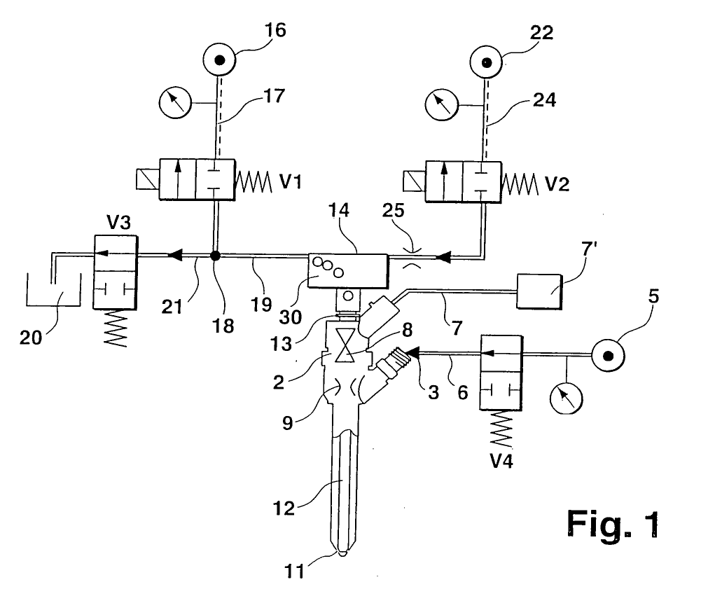

The arrangement 1 shown in FIG. 1 schematically shows an injector 2, installed in the arrangement, for common rail operation, having a high-pressure connection 3 for the liquid test medium, which is free of gaseous air. This medium can be supplied from a connection 5, at which the test medium is available at high pressure, via a pipeline 6. In the test field, the injector 2 has been inserted into the completely empty state, that is, filled only with air, into the arrangement 1 is shown, or with a mixed filling (air and a test medium), for instance in the case of repeated tests.

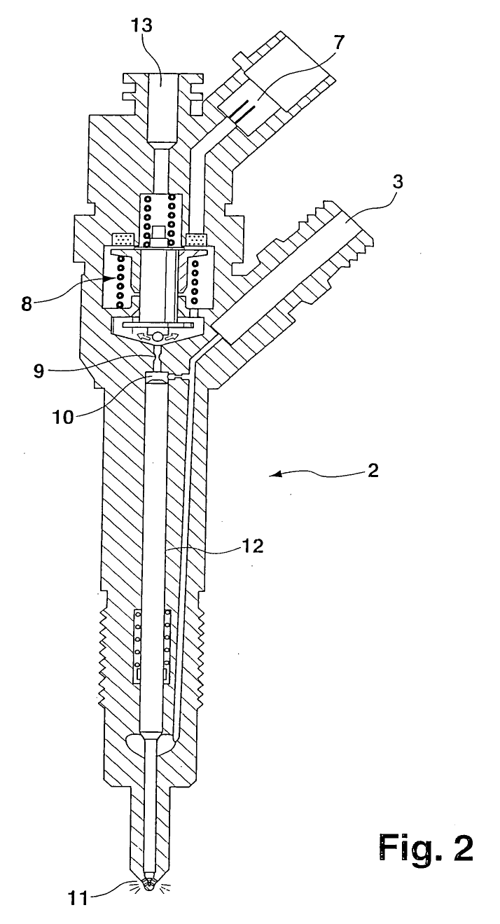

In the example, the injector has a connection 7 for electrically triggering a magnetic control valve 8, which upon triggering reduces the pressure in a control chamber 10 (FIG. 2) via an outflow throttle 9 in order to control the opening of injection openings 11 by means of a valve piston 12.

Leak fuel quantities, which depending on the embodiment of the injector also a relatively large return quantity that occurs during operation, from the injector flow away from the injector via a connection 13 (low-pressure connection, leakage connection). In this example, this connection is not connected directly to a pipeline, serving for instance as a return line into the fuel tank, but instead to an adaptor head 14, which makes it possible to connect the connection 13 to other connections of the arrangement.

This includes a vacuum pump 16, which via a pipeline 17 and a pipe branch 18 is in communication with a pipeline 19 communicating with the adaptor head; it also includes a tank 20 for receiving the aforementioned return quantity, which tank is in communication with the pipe branch 18 via a pipeline 21. A low-pressure connection 22 for a low-pressure medium, in this case called a flushing medium, is also provided; via a pipeline 24 and a throttle 25, it is supplied to a connection, diametrically opposite the pipeline 19, of the adaptor head 14. As a result, the flushing medium can flush air bubbles 30, which reach the adaptor head 14 from the injector 2, out in the direction toward the left in the drawing. The function of the entire arrangement is controlled by switching valves, specifically one switching valve V1 in the line 17, one switching valve V2 in the line 24, one switching valve V3 in the line 21, and one switching valve V4 in the line 6. Electrical control terminals of the switching valves are connected to a control device that controls the sequence of the method.

The function sequence will now be explained in terms of the curve courses shown in FIG. 3, which with their bottom line indicate the closed state of the associated switching valve and with their line extending above the bottom line indicate the opened state of that switching valve.

Initially, all the switching valves V1 through V4 are blocked. The switching valves V1 and V4 are then opened; that is, underpressure is applied to the arrangement, and simultaneously, medium at the high pressure (for instance, 1600 bar for a typical injector) is supplied to the connection 3 of the injector 2.

The underpressure generated by the vacuum pump 16 acts on the connection 13 of the injector via the adaptor head 14 and also on the hydraulic internal volume of the injector, as long as the injector is in communication with the connection 13, and in particular acts on the chamber in which the control valve is located. Simultaneously, via the pipelines 17 and 19, the adaptor head 14, and the connection 13, the vacuum aspirates test medium out of the injector; initially, the first time, there may possibly still be a very great deal of air that is not in the form of bubbles. Any air bubbles originally present have increased in size relative to their original state because of the vacuum (if the pressure is reduced from 1 bar to 0.1 bar, for instance, they will have approximately doubled in diameter) and now can no longer catch so easily on any protrusions and are therefore flushed out by the constantly produced return quantity from the injector.

Via a trigger circuit 7′, coupled to the aforementioned control device, a trigger signal is supplied to the electrical terminal 7 and triggers the injector, in this example, in the usual way for operation of an internal combustion engine; in this example, it does so with 1000 electrical pulses per minute, so that per minute, the control valve 8 executes 1000 opening and closing events. (This is very much faster than the switching frequency of the control valve 2, for instance.) During that time, leakage fluid and control fluid, which occurs in the stroke of the valve piston 12, flows out through the connection 13 and, because of the existing underpressure in the region of the control valve, flushes out air bubbles, which are enlarged compared to normal operation. The flushed-out air bubbles reach the adaptor head 14, where in a preferred embodiment of the method they are flushed out of the adaptor head by flushing medium, which is released by the valve V2 a total of three times in the example shown, and as a result the elimination of air from the vicinity of the injector is reinforced.

For the sake of simple handling of the system, the vacuum pump 16 is embodied such that it aspirates not only air but also any medium or fuel that occurs. In other embodiments of the method and the apparatus, the vacuum pump 16 aspirates only air; the mixture of air bubbles and liquid medium flowing vertically upward through the line 17 in this example passes from above, still under a vacuum, into a collection tank, where the liquid medium accumulates, and the vacuum pump is connected above the collection tank and thus does not come into contact with the liquid medium. The aforementioned collection tank must be emptied from time to time.

Once the aforementioned arrangement 1 as just described has been in operation for a few seconds, for instance, the switching valve V1 (vacuum) will have been closed in the meantime. In this example, this is followed by a single flushing operation as well. The high-pressure supply of test medium via the switching valve V4 is maintained, and the switching valve V3 is opened, so that the now sufficiently air-free medium continuing to emerge from the low-pressure connection 13 of the injector 2 is delivered, given further delivery of the medium to the high-pressure connection 3, through the valve V4 to the collection tank 20, as is provided in normal operation in the motor vehicle, and can be measured (quantified) as needed.

Following the time sequence of the activity of the valves described here, a measurement of the properties of the injector may now be made in the test field, or in the case of a combustion injection valve freshly inserted into an internal combustion engine, this injection valve is air-free, and the arrangement used for making it air-free can be removed from the engine after the engine is shut off, and then standard connections of the engine, which must be undone in order to attach the measuring equipment, are restored again.

In FIG. 1, measuring instruments or points, symbolized by pointer instruments, for the vacuum, the low-pressure flushing medium and the high-pressure test medium are provided, by which the activity of the system can be monitored and its measurement values can be recorded in a log.

At the times t1 through t6 shown in FIG. 3, of which t1 is shortly before the opening of the valves V1 and V4 and t6 is shortly after the closure of V1, but the valve V2 is still open (carrying liquid), and the other times are each associated with open and blocked states of the valve V2, the following absolute pressures prevail in the region of the low-pressure connection 13 of the injector 2, along with the associated relative sizes of the individual air bubbles in the region of the control valve 8, expressed in the form of volumes:
t1: absolute pressure 0.1 bar, air bubble volume 10;
t2: absolute pressure 2.6 bar, air bubble volume 0.38;
t3: absolute pressure 0.1 bar, air bubble volume 10;
t4: absolute pressure 2.6 bar, air bubble volume 0.38;
t5: absolute pressure 0.1 bar, air bubble volume 10;
t6: absolute pressure 4 bar, air bubble volume 0.25.

FIG. 3 must be understood solely as an illustration; in practice, more flushing operations (or not even a single flushing operation) and multiple repetitions of the operation shown may be performed.

In the performance of the method of the invention and in the activity of the apparatus of the invention, the number and in particular the total volume of the air bubbles present in the injector decreases steadily, because new, air-free medium is constantly being supplied to the connection 3, and after a short time, at most after only a few seconds, the injector is practically air-free, and measurements can now be made exactly at the injector.

If the described apparatus 1 is to be used for instance in a professional automotive facility for instance to install a repaired and still air-filled injector in an internal combustion engine, then all that is needed is to connect the above-described system parts to the injector, that is, the adaptor head, and with it the vacuum pump. The supply of high-pressure medium, in this case specifically diesel fuel, already exists in the motor vehicle, without special provisions being required. It may be that in this case difficulties arise in furnishing a low-pressure flushing medium, namely once again specifically diesel fuel. In that case, the adaptor head for use in the professional facility would not have a connection for flushing medium, or that connection would be closed.

It may be practical to free still other injectors, such as injectors of the kind those that put fuel of relatively low pressure at the injection pressure via a built-in compressor, of air inclusions by using the invention.

It is assumed that the influence of air bubbles in a magnet valve, as has just been explained, is especially troublesome, because for instance a delay in the opening motion of the armature of the magnet valve, or a faster opening motion as a consequence of air inclusions, compared to the desired state, leads to a delayed or accelerated increase in the magnetic force acting on the armature, making the influence on the function of the magnet valve especially strong.

The invention can also be usefully applied to other types of control valves, in particular in the case of a control valve that is actuated via a piezoelectric actuator, even if this actuator, because of the absence of the just-described joint coupling effect in the case of an electromagnetic valve might possibly be less strongly affected in its function by the presence of air bubbles. In both types of valves mentioned, it may be especially troublesome that once a largely air-filled injection valve is put into operation, the development of foam can initially occur in the region where the moving parts of the control valve are located, making measurement more difficult or even impossible. Such injectors, which if a hydraulic coupler is present require a counterholding pressure at the leakage connection of 10 bar, for instance, in normal operation, can be freed of air inclusions in the way described here and in the process normally be exposed to the aforementioned low pressure of 0.1 bar, which not applied for very long.

1-9. (canceled)

10. A method for flushing air from injection valve such as a common rail injector for an internal combustion engine which injection valve on being put into operation is initially at least partly filled with air and to which a liquid medium is supplied via a typical connection for supplying fuel, the method comprising pressurizing an inner chamber of the injection valve to a pressure that is reduced compared to normal operation, whereby existing air bubbles increase in volume compared to the volume in normal operation, and flushing the medium contained in said inner chamber, at a reduced pressure that remains at least approximately constant, and selectively repeating these steps multiple times.

11. The method according to claim 10, further comprising supplying control signals for opening and closing the injection to the injection valve.

12. The method according to claim 10, further comprising supplying a low-pressure medium to reinforce the flushing out of the medium after leaving the injection valve.

13. The method according to claim 11, further comprising supplying a low-pressure medium to reinforce the flushing out of the medium after leaving the injection valve.

14. An apparatus for performing the method according to claim 10, the apparatus comprising:
an adaptor head (14), to be connected to a low-pressure connection or leakage connection of the injection valve (2), which adaptor head can be made to communicate with a vacuum pump (16), and a device for supplying medium at high pressure to a standardly provided connection of the injection valve.

15. An apparatus for performing the method according to claim 11, the apparatus comprising:
an adaptor head (14), to be connected to a low-pressure connection or leakage connection of the injection valve (2), which adaptor head can be made to communicate with a vacuum pump (16), and a device for supplying medium at high pressure to a standardly provided connection of the injection valve.

16. An apparatus for performing the method according to claim 12, the apparatus comprising:
an adaptor head (14), to be connected to a low-pressure connection or leakage connection of the injection valve (2), which adaptor head can be made to communicate with a vacuum pump (16), and a device for supplying medium at high pressure to a standardly provided connection of the injection valve.

17. An apparatus for performing the method according to claim 13, the apparatus comprising:
an adaptor head (14), to be connected to a low-pressure connection or leakage connection of the injection valve (2), which adaptor head can be made to communicate with a vacuum pump (16), and a device for supplying medium at high pressure to a standardly provided connection of the injection valve.

18. The apparatus according to claim 14, wherein the adaptor head (14) has a connection that is in communication with a low-pressure connection for a flushing medium.

19. The apparatus according to claim 14, wherein the apparatus further comprise a return tank (20) for the return quantity in communication with the adaptor head (14).

20. The apparatus according to claim 18, wherein the apparatus further comprise a return tank (20) for the return quantity in communication with the adaptor head (14).

21. The apparatus according to claim 14, further comprising at least one switching valve (V1, V2, V3, V4) for controlling chronological events of the apparatus.

22. The apparatus according to claim 15, further comprising at least one switching valve (V1, V2, V3, V4) for controlling chronological events of the apparatus.

23. The apparatus according to claim 16, further comprising at least one switching valve (V1, V2, V3, V4) for controlling chronological events of the apparatus.

24. The apparatus according to claim 17, further comprising at least one switching valve (V1, V2, V3, V4) for controlling chronological events of the apparatus.

25. The apparatus according to claim 21, further comprising a control device connected to a control terminal of the at least one switching valve (V1, V2, V3, V4).

26. The apparatus according to claim 22, further comprising a control device connected to a control terminal of the at least one switching valve (V1, V2, V3, V4).

27. The apparatus according to claim 23, further comprising a control device connected to a control terminal of the at least one switching valve (V1, V2, V3, V4).

28. The apparatus according to claim 24, further comprising a control device connected to a control terminal of the at least one switching valve (V1, V2, V3, V4).

29. The apparatus according to claim 25, wherein the control device is coupled to an electrical terminal of the injector.
